(19) United States
(12) Patent Application Publication
(10) Pub. No.: US 2026/0134434 A1
(43) Pub. Date: May 14, 2026

(54) SYSTEMS AND METHODS FOR RISK MITIGATION IN REAL-TIME PAYMENT TRANSACTIONS

(71) Applicant: Early Warning Services, LLC, Scottsdale, AZ (US)

(72) Inventors: Praveen Kumar Taneja, Chicago, IL (US); Shikha Singh, Aurora, IL (US); William Clayton Meyer, Lakeland, FL (US)

(73) Assignee: Early Warning Services, LLC, Scottsdale, AZ (US)

(21) Appl. No.: 19/388,665

(22) Filed: Nov. 13, 2025

Related U.S. Application Data
(60) Provisional application No. 63/720,680, filed on Nov. 14, 2024.

(51) Int. Cl. G06Q 20/40; G06N 20/20

(52) U.S. Cl. CPC G06Q 20/4016; G06N 20/20; G06Q 20/407

(57) ABSTRACT

A computer-implemented method including receiving, at a system from a sender financial institution, transaction information for a requested payment transaction from a sender to a recipient. The system is in data communication with a plurality of financial institutions of a payment network. The plurality of financial institutions include the sender financial institution, a recipient financial institution, and multiple other financial institutions. The method also can include generating, using one or more machine-learning models, a risk score for the requested payment transaction based on analyzing the transaction information received from the sender financial institution and historical information regarding sender behavior of the sender and recipient behavior of the recipient obtained from the plurality of financial institutions of the payment network. The method additionally can include sending the risk score to the sender financial institution to cause the sender financial institution to determine whether to approve or deny the requested payment transaction. Other embodiments are described.

### CROSS-REFERENCE TO RELATED APPLICATION

This application claims the benefit of U.S. Provisional Application No. 63/720,680, filed Nov. 14, 2024. U.S. Provisional Application No. 63/720,680 is incorporated herein by reference in its entirety.

### TECHNICAL FIELD

This disclosure relates generally to risk mitigation in real-time payment transactions.

### BACKGROUND

Electronic payment systems have become increasingly prevalent in modern financial transactions. These systems allow users to transfer funds quickly and conveniently between accounts, often using mobile devices or online platforms. As the adoption of such payment systems has grown, so too has the expectation for robust security measures to protect users from fraud and unauthorized transactions. Person-to-person (P2P) payment platforms, in particular, have gained popularity for their ease of use in transferring money between individuals. These systems typically allow users to link their bank accounts or debit cards and send money to others using email addresses or phone numbers. While convenient, P2P payments also present unique challenges in terms of risk assessment and fraud prevention. Traditional fraud detection methods often rely on analyzing patterns of behavior within a single financial institution. However, this approach can have limitations when applied to P2P transactions, which frequently involve parties using different financial institutions. Additionally, fraudsters can exploit the speed and convenience of P2P systems by conducting unauthorized transactions before they can be detected and stopped.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for risk mitigation in real-time payment transactions, showing examples of activities performed by the components of the system, according to an embodiment; and

FIG. 4 illustrates a flowchart for a method of risk mitigation in real-time payment transactions, according to another embodiment.

For simplicity and clarity of illustration, the drawing figures herein illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, two minutes, five minutes, or ten minutes.

### DESCRIPTION OF EXAMPLES OF EMBODIMENTS

In many embodiments, risk assessment and mitigation can be performed to evaluate transactions holistically, taking into account data from multiple sources and financial institutions. In many embodiments, these tools can be able to process large volumes of transaction data in real-time, identify potential risks, and provide risk assessment scores and/or information to financial institutions.

Various embodiments include a computer-implemented method. The method can include receiving, at a system from a sender financial institution, transaction information for a requested payment transaction from a sender to a recipient. The system is in data communication with a plurality of financial institutions of a payment network. The plurality of financial institutions include the sender financial institution, a recipient financial institution, and multiple other financial institutions. The method also can include generating, using one or more machine-learning models, a risk score for the requested payment transaction based on analyzing the transaction information received from the sender financial institution and historical information regarding sender behavior of the sender and recipient behavior of the recipient obtained from the plurality of financial institutions of the payment network. The method additionally can include sending the risk score to the sender financial institution to cause the sender financial institution to determine whether to approve or deny the requested payment transaction.

A number of embodiments include a system including one or more processors and one or more non-transitory computer-readable media storing computing instructions that, when executed on the one or more processors, cause the one or more processors to perform operations. The operations can include receiving, at the system from a sender financial institution, transaction information for a requested payment transaction from a sender to a recipient. The system is in data communication with a plurality of financial institutions of a payment network. The plurality of financial institutions include the sender financial institution, a recipient financial institution, and multiple other financial institutions. The method also can include generating, using one or more machine-learning models, a risk score for the requested payment transaction based on analyzing the transaction information received from the sender financial institution and historical information regarding sender behavior of the sender and recipient behavior of the recipient obtained from the plurality of financial institutions of the payment network. The method additionally can include sending the risk score to the sender financial institution to cause the sender financial institution to determine whether to approve or deny the requested payment transaction.

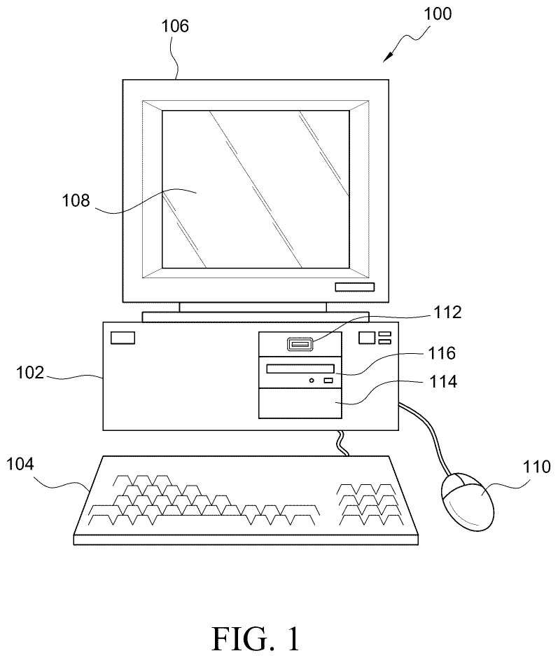

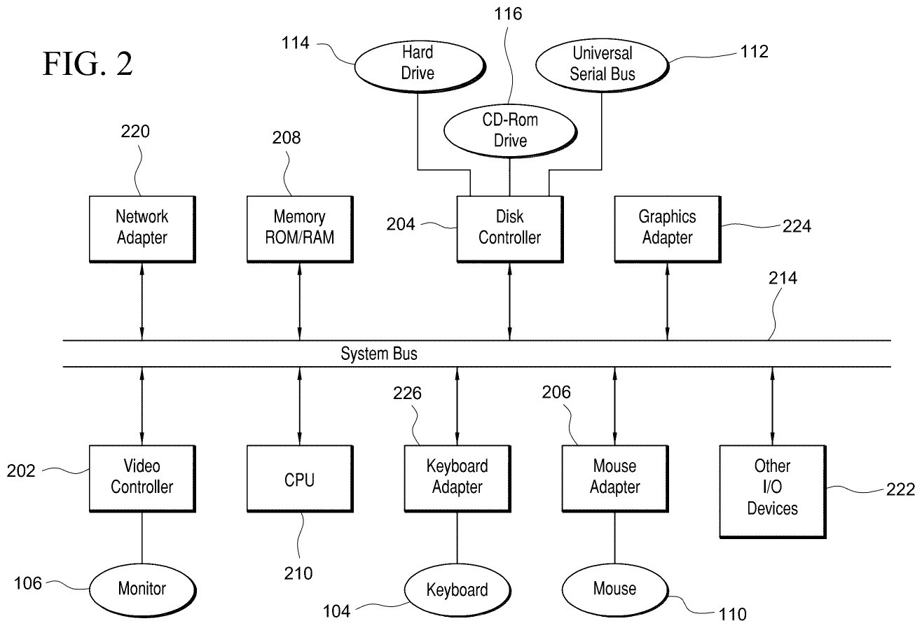

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIGS. 1-2). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general-purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) or Field Programmable Gate Arrays (FPGAs) can be programmed to carry out one or more of the systems and procedures described herein. For example, one or more of the programs and/or executable program components described herein can be implemented in one or more ASICs or FPGAs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

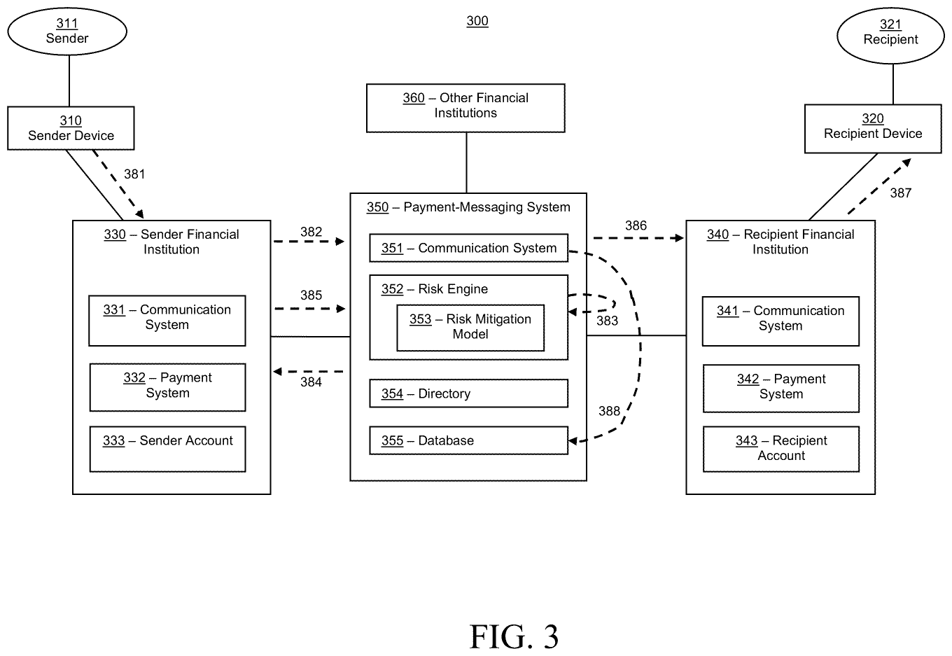

Turning ahead in the drawings, FIG. 3 illustrates a block diagram of a system 300 that can be employed for risk mitigation in real-time payment transactions, showing examples of activities performed by the components of system 300, according to an embodiment. System 300 is merely exemplary, and embodiments of the system are not limited to the embodiments presented herein. The system can be employed in many different embodiments or examples not specifically depicted or described herein. In some embodiments, certain elements of system 300 can perform various procedures, processes, and/or activities. In other embodiments, the procedures, processes, and/or activities can be performed by other suitable elements of system 300. Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a sender device 310 used by a sender 311, a recipient device 320 used by a recipient 321, a sender financial institution 330, a recipient financial institution 340, a payment-messaging system 350, and/or other financial institutions 360. Sender device 310, recipient device 320, sender financial institution 330, recipient financial institution 340, payment-messaging system 350, and/or other financial institutions 360 can each be or include a computer system, such as computer system 100 (FIG. 1), as described above, and can each be a single computer, a single server, or a cluster or collection of computers or servers, or a cloud of computers or servers. In some embodiments, various systems of system 300 (e.g., sender device 310, recipient device 320, sender financial institution 330, recipient financial institution 340, payment-messaging system 350, and/or other financial institutions 360) can be in data communication with one or more of the other systems of system 300 through one or more networks, such as the Internet or other suitable networks (not shown).

In a number of embodiments, sender device 310 can be used by sender 311, which can be a person or entity that can make an electronic payment to recipient 321 using system 300. In many embodiments, sender 311 can hold a sender account 333 at sender financial institution 330. Sender account 333 can be an account used to fund the payment, such as a demand deposit account of sender 311 maintained at sender financial institution 330. In a number of embodiments, sender 311 can access sender financial institution 330 through sender device 310, such as through a website, a mobile application, or a mobile wallet provided by sender financial institution 330. In a number of embodiments, sender device 310 can communicate with a communication system 331 at sender financial institution 330, such as a payment system 332 provided by sender financial institution 330.

In several embodiments, recipient device 320 can be used by recipient 321, which can be a person or entity that can receive a payment from sender 311 using system 300. In many embodiments, recipient 321 can hold a recipient account 343 at a recipient financial institution 340. Recipient account 343 can be an account used to receive the payment, such as a demand deposit account of recipient 321 at recipient financial institution 340. In a number of embodiments, recipient 321 can access recipient financial institution 340 through recipient device 320, such as through a web application, a mobile application, or a mobile wallet provided by recipient financial institution 340. In a number of embodiments, recipient device 320 can communicate with a communication system 341 at recipient financial institution 340, such as a payment system 342 provided by recipient financial institution 340.

In many embodiments, payment-messaging system 350 can be in data communication with various financial institutions, such as sender financial institution 330, recipient financial institution 340, and other financial institutions 360, which collectively, along with payment-messaging system 350, can be referred to as a payment network. In some embodiments, payment-messaging system 350 can be a payment-messaging network provided by an entity separate from sender financial institution 330 and recipient financial institution 340, such as the Zelle® network provided Early Warning Services, LLC, of Scottsdale, Arizona, or another suitable entity. In some embodiments, a settlement network (not shown) can be in data communication with various financial institutions, such as sender financial institution 330, recipient financial institution 340, and other financial institutions 360, and in some embodiments, the settlement network can be in data communication with payment-messaging system 350, and can be a network, such as ACH (Automated Clearing House), RTP® (Real Time Payments) by The Clearing House, or another suitable settlement network.

In many embodiments, sender device 310 and/or recipient device 320 can be desktop computers, laptop computers, mobile devices, computer servers, and/or other endpoint devices. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand.

Exemplary mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, and/or (ii) the Android™ operating system developed by the Open Handset Alliance.

In many embodiments, payment-messaging system 350 and/or the systems of sender financial institution 330, recipient financial institution 340, and/or other financial institutions 360 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to payment-messaging system 350 and/or the systems of sender financial institution 330, recipient financial institution 340, and/or other financial institutions 360 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of payment-messaging system 350 and/or the systems of sender financial institution 330, recipient financial institution 340, and/or other financial institutions 360. In a similar manner, the processors and/or the non-transitory computer-readable media can be local and/or remote to each other.

Meanwhile, in many embodiments, payment-messaging system 350 and/or the systems of sender financial institution 330, recipient financial institution 340, and/or other financial institutions 360 also can be configured to communicate with one or more databases. For example, payment-messaging system 350 can include one or more database systems, such as directory 354 and/or database 355. Directory 354 can include profile information about users that have registered to facilitate payments using payment-messaging system 350. For example, once sender 311 registers with payment-messaging system 350, such as through sender financial institution 330, sender financial institution 330 can provide a payment profile identification data structure to payment-messaging system 350, which can include one or more public identifiers of sender 311, such as an email address, phone number, or other suitable public identifier of sender 311, and can include a tokenized identifier (e.g., a Zelle tag provided by the Zelle network), which can represent sender account 333 without including the account number of sender account 333. In many embodiments, the tokenized identifier can be provided to payment-messaging system 350 by sender financial institution 330 when sender 311 registers to use payment-messaging system 350. In many embodiments, sender financial institution 330 can maintain a mapping from the tokenized identifier to account information for sender account 333. In many embodiments, database 355 can maintain a record of transaction requests, approved transactions, denied transactions, risk determinations, and/or other suitable information, which can be used in determining risk by a risk engine 352 of payment-messaging system 350.

The one or more databases (e.g., 354, 355) can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple memory storage units storing the one or more databases, depending on the size of the particular database and/or the storage capacity of the memory storage units. The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, payment-messaging system 350, sender financial institution 330, recipient financial institution 340, other financial institutions 360, and/or one or more of the databases (e.g., 354, 355) can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, payment-messaging system 350 can include a communication system 351, risk engine 352, directory 354, and/or database 355. In many embodiments, the systems of payment-messaging system 350 can be modules of computing instructions (e.g., software modules) stored at non-transitory computer readable media that operate on one or more processors. In other embodiments, the systems of payment-messaging system 350 can be implemented in hardware. Payment-messaging system 350 can be a computer system, such as computer system 100 (FIG. 1), as described above, and can be a single computer, a single server, or a cluster or collection of computers or servers, or a cloud of computers or servers. Additional details regarding payment-messaging system 350 and the components thereof are described herein.

In many embodiments, system 300 can provide risk mitigation in electronic payment transactions, such as real-time payments. In various aspects, a risk mitigation model 353 can be implemented in risk engine 352 to predict and prevent potentially fraudulent transactions across the payment network of financial institutions (e.g., 330, 340, 360). Risk mitigation model 353 can utilize machine-learning algorithms and real-time data analysis to evaluate transaction risk. In some embodiments, risk mitigation model 353 can generate a risk score for a requested payment transaction. The risk score can represent a predicted level of risk associated with the transaction. A higher risk score can indicate a greater chance that the transaction is fraudulent. Risk mitigation model 353 can analyze various features and data points related to the transaction. In certain implementations, risk mitigation model 353 can evaluate information about both sender 311 and recipient 321 involved in the transaction. The evaluation can include analyzing current transaction details as well as prior activity and transaction history for the parties (e.g., sender 311, recipient 321) across multiple financial institutions in the payment network (e.g., 330, 340, 360).

In some aspects, risk mitigation model 353 can be implemented as part of risk engine 352 that processes transaction requests in real-time. Risk engine 352 can receive transaction information from sender financial institution 330, analyze the information associated with the transaction using risk mitigation model 353, determine and/or generate a risk assessment of the transaction, and return the risk assessment to sender financial institution 330 to aid sender financial institution 330 in determining whether to approve sending the transaction. Risk mitigation model 353 can provide a more comprehensive fraud detection approach compared to analysis performed by individual financial institutions. In some embodiments, risk mitigation model 353 can leverage network-wide data to identify patterns and risk factors that may not be apparent when examining activity at a single financial institution.

In many embodiments, risk mitigation model 353 an include one or more predictive models that can predict the likelihood of a transaction being fraudulent. The machine-learning algorithm can determine information patterns that are used to generate the risk score for a given transaction. Risk mitigation model 353 can analyze a various number of features (e.g., dozens of features), which can be inputs to risk mitigation model, to calculate the risk score. In certain aspects, risk mitigation model 353 can evaluate features related to behavior of sender 311, behavior of recipient 321, and transaction characteristics. Risk mitigation model 353 can analyze factors such as transaction amounts, frequency of interactions between parties, account usage patterns, and reported fraud incidents associated with involved parties or linked accounts. In some embodiments, the features can be different data points regarding the transaction, which can be used to calculate the risk score. In certain implementations, risk mitigation model 353 can evaluate sender behavior across multiple financial institutions (e.g., 330, 340, 360) within the network. This comprehensive analysis can allow risk mitigation model 353 to identify patterns or risk factors that may not be apparent when examining activity at a single financial institution. For example, risk mitigation model 353 can consider the transaction history of sender 311 at sender financial institution 330, recipient financial institution 340, and/or other financial institutions 360, how active the sender has been in sending and/or receiving payments through payment-messaging system 350, typical transaction amounts, the amount requested for this transaction, and the frequency of interactions with various recipients across various different financial institutions of the payment network. Similarly, risk mitigation model 353 can assess behavior of recipient 321 across multiple financial institutions in the payment network (e.g., 330, 340, 360). This evaluation can include analyzing factors such as the transaction history of recipient 321 at recipient financial institution 340, sender financial institution 330 and/or other financial institutions 360, how frequently recipient 321 interacts with new senders, the typical amounts received, the amount requested for this transaction, and any history of reported fraudulent activity associated with recipient 321 or accounts linked to recipient. By examining behavior of recipient 321 across the entire network, risk mitigation model 353 can be better equipped to identify potential fraudulent patterns that could be missed by institution-specific controls, as the fraudsters are typically the recipients. Risk mitigation model 353 also can evaluate prior fraud reports from any financial institution (e.g., 330, 340, 360) involving sender 311 and identifying information associated with sender 311, including tokens associated with sender 311, as well as recipient 321 and identifying information associated with recipient 321, including tokens associated with recipient 321. Information considered from the fraud reporting can include whether there has been fraud reported, how many times, by whom, etc. In many embodiments, risk mitigation model 353 can continuously update its model based on new transaction data and reported fraud incidents, allowing it to adapt to evolving fraud patterns and maintain its effectiveness in identifying potential risks. This dynamic approach can enable risk engine 352 to provide more accurate and up-to-date risk assessments for each transaction processed through the payment-messaging system 350.

In many embodiments, the outputs of the model can include the risk score and/or supplemental data about the risk determination, such as features that played a prominent role in the score. In a number of embodiments, the risk score generated by risk mitigation model 353 can be represented on a scale, which in some cases may range from 0 to 1000, or another suitable range. In other embodiments other types of scores can be used, such as alphabetic scores, alpha-numeric scores, etc. On this scale, higher scores can generally indicate a higher level of perceived risk associated with the transaction, or vice versa. In many embodiments, financial institutions (e.g., sender financial institution 330) can use this score, along with other factors, to make informed decisions about whether to approve or deny a transaction. In certain embodiments, payment-messaging system 350 can provide sender financial institution 330 (and/or recipient financial institution 340 and/or other financial institutions 360) with additional information along with the risk score generated by the risk engine 352. This supplementary data may include attributes and features used in the risk assessment model, which can offer financial institutions greater insight into the factors contributing to a particular risk score. For instance, the supplemental data can highlight specific behavioral patterns or transaction characteristics that influenced the risk assessment, enabling financial institutions to make more informed decisions about transaction approvals.

In many embodiments, risk mitigation model 353 can be trained on historical transaction data and continuously updated to adapt to evolving fraud patterns. Training of the model can involve determining weights, biases, and/or parameters for the model. Various machine-learning techniques can be employed in risk mitigation model 353. In some implementations, an ensemble model can be used. In some embodiments, a gradient-boosted decision-tree model, e.g., XGBoost, can be used to generate a risk score for each transaction. Other examples of machine-learning techniques that can be used are decision trees, logistic or linear regression, K-Nearest-Neighbors, Support Vector Machines, neural networks, fuzzy logic, GANs (generative adversarial networks), etc. In various embodiments, each of the machine-learning models used can be trained dynamically and/or regularly. In many embodiments, the systems and/or methods can be configured to train or retrain the one or more machine-learning models. The training of each of the machine-learning models can be supervised, semi-supervised, and/or unsupervised, which in some embodiments can be followed by, or used in conjunction with, other techniques, such as reinforcement machine-learning techniques. The training data or retraining of training datasets for each of the machine-learning models can be collected from various data sources, including historical input and/or output data by the machine-learning models. The collection and update of the training or retraining data in the training datasets can be performed once, periodically (e.g., every day, every week, etc.), or constantly. For example, in certain embodiments, the input and/or output data of a machine-learning model can be curated by a user (e.g., a machine-learning engineer, a data scientist, etc.) or automatically collected every time the machine-learning model generates new output data to update the training datasets for retraining the machine-learning model. In many embodiments, the trained and/or retrained machine-learning model as well as the training datasets can be stored in, updated, and accessed from a database (e.g., database 355).

In some embodiments, the systems, methods, and/or system users (e.g., a data scientist) further can determine whether to add the newly created historical input and/or output data to the training dataset for retraining the machine-learning models based upon user feedback, predetermined criteria, and/or confidence scores for the historical output data. The user feedback can be associated with the output data of the machine-learning models or the output of the systems and/or methods using the machine-learning models. In several embodiments, the one or more machine-learning models can be configured to start or stop automatically upon occurrence of predefined events and/or conditions. In certain embodiments, the systems and/or methods can use a pretrained machine-learning model, without any retraining.

In some embodiments, risk engine 352 can incorporate advanced analytical capabilities to enhance its fraud detection and risk assessment functions. In some aspects, risk engine 352 can consider seasonality factors when evaluating transaction risk. For example, risk engine 352 can adjust its risk assessment algorithms during periods known for increased fraudulent activity, such as tax season. This dynamic approach can allow risk engine 352 to adapt to temporal patterns in fraud attempts and provide more accurate risk assessments during these high-risk periods.

In some embodiments, risk engine 352 also can analyze the memo line of transactions. This analysis can involve natural language processing techniques to identify potential red flags or suspicious patterns in the transaction descriptions provided by users. By examining the content of memo lines, risk engine 352 can gain additional context about the nature of transactions and potentially uncover attempts to disguise fraudulent activities.

In some embodiments, payment-messaging system 350 can offer guidance to financial institutions regarding risk scores. For example, payment-messaging system 350 can suggest benchmark values for different risk levels, which financial institutions can use as a starting point for their risk management strategies. For example, the system can indicate that scores above 800 on a 0-1000 scale are considered very-high-risk transactions. However, these thresholds can be adjustable as fraud risks change over time.

In some aspects, risk engine 352 can be implemented on a third-party Software-as-a-Service (SaaS) platform. A cloud-based implementation can offer scalability, flexibility, and robust computational resources to support the complex analytical processes performed by risk engine 352. The use of a third-party SaaS platform also can facilitate regular updates and improvements to the risk assessment model without significant infrastructure changes for participating financial institutions.

FIG. 3 also shows activities 381-388 that can be performed by various components of system 300. These activities are merely an example, and the activities are not limited to the embodiments presented herein. Various activities can be employed in many different embodiments or examples not specifically depicted or described herein. In some embodiments, the activities can be performed in the order presented. In other embodiments, the activities can be performed in any suitable order. In still other embodiments, one or more of the activities can be combined or skipped.

Referring to FIG. 3, activity 381 can involve sender device 310 initiating a transaction request to sender financial institution 330. The transaction request can include details such as information about sender 311, information about recipient 321 (e.g., a public identifier of recipient 321), and/or the amount to be transferred. In many embodiments, activity 381 can be performed through a mobile banking application or online banking platform used by sender 311 on sender device 310.

Next, activity 382 can involve sender financial institution 330 communicating the transaction details to payment-messaging system 350. This communication can include sending relevant information about sender 311, recipient 321, and the transaction to payment-messaging system 350. In some embodiments, sender financial institution 330 can determine the relevant information from the current transaction request, from prior transaction requests and activity, or both.

Next, activity 383 can include risk engine 352 and/or risk mitigation model 353 within payment-messaging system 350 evaluating the transaction for potential risks. This evaluation can involve analyzing various data points and features related to the transaction, sender, and recipient to generate a score, such as described above. In many embodiments, activity 383 can utilize machine-learning algorithms to generate a risk score for the transaction, such as described above.

Next, activity 384 can involve payment-messaging system 350 sending the score and/or supplemental data to sender financial institution 330, to allow sender financial institution 330 to determine whether to approve or deny the transaction. In many embodiments, sender financial institution 330 can use the score and/or the supplemental data with or without other information known to sender financial institution 330 in determining whether to approve or deny the transaction. Each financial institution can have its own respective risk tolerance, and can have access to its own sources of information beyond what is considered in the risk evaluation in activity 383, so different financial institutions can make different decisions depending on their risk tolerance and internal analysis. In some embodiments, payment-messaging system 350 can send the score and/or supplemental data to recipient financial institution 340 at the same time the score and/or supplemental data is sent to sender financial institution 330. In some embodiments, payment-messaging system 350 can send the score and/or supplemental data upon request by recipient financial institution 340.

Next, activity 385 can involve sender financial institution 330 sending a communication to payment-messaging system 350 that can indicate if the transaction is approved or denied. For example, if the transaction is approved by sender financial institution 330, sender financial institution 330 can request that the transaction be processed through payment-messaging system 350, or sender financial institution 330 can send payment-messaging system 350 an approval message and can initiate the fund transfer process. If the transaction is denied by sender financial institution 330, the transaction can be marked as denied, the transaction does not proceed and sender financial institution 330 does not request that the transaction be processed through payment-messaging system 350, or sender financial institution can send payment-messaging system 350 a denial message that postpones or terminates the fund transfer process. In some embodiments, the approval or denial message sent in activity 385 can include details about the reasoning behind the decision, such as an evaluated risk, determined score, or other such information related to the transaction. If approved, information about the approval and/or the transaction can be added to database 355.

When the transaction is approved, activity 386 can be performed, which can involve payment-messaging system 350 sending one or more payment messages to recipient financial institution 340 to cause recipient financial institution to make funds available in real-time in recipient account 343 for the payment amount of the transaction. After activity 386, activity 387 can involve recipient financial institution 340 notifying recipient 321 through recipient device 320 that the payment has been received and funds are available in recipient account 343. This notification can be delivered through various channels, such as text messaging (e.g., SMS (Short Message Service)), email, or push notifications within a banking application on recipient device 320.

When the transaction is not approved, activity 388 can be performed, which can involve marking the transaction as denied and adding that denial information, along with other information about the transaction in database 355. For example, transaction details, risk assessment results, sender information, recipient information, and other relevant information can be stored in database 355 for future reference and analysis. In many embodiments, activity 388 can be performed continuously throughout the transaction process to ensure all data is accurately recorded and readily accessible for future risk assessments. In some embodiments, payment-messaging system 350 can use approval and/or denial information to further refine its risk mitigation model 353, such as to update and/or retrain risk mitigation model 353.

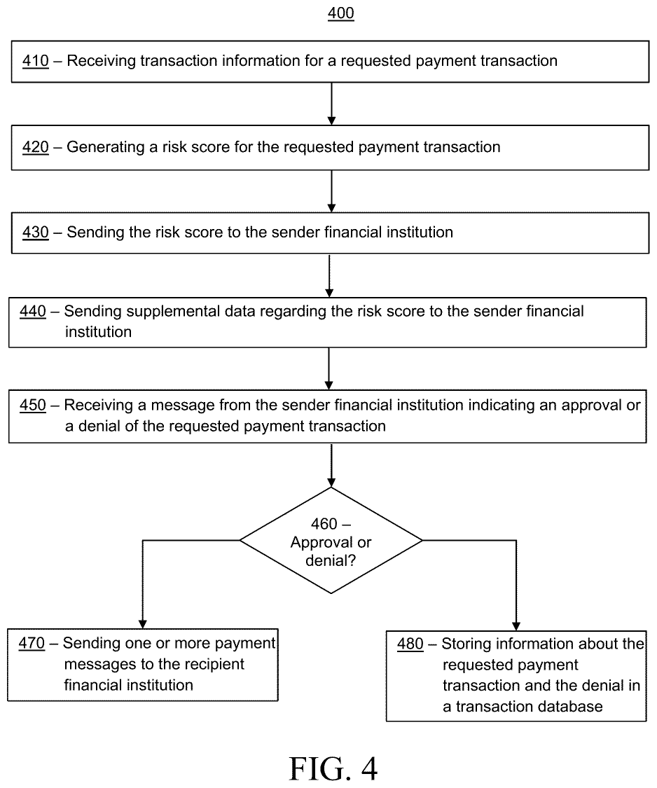

Turning ahead in the drawings, FIG. 4 illustrates a flowchart for a method 400 of risk mitigation in real-time payment transactions, according to another embodiment. Method 400 is merely an example, and the method is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, payment-messaging system 350 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of payment-messaging system 350 (FIG. 3). The processor(s) can be similar or identical to the processor(s) described above with respect to computer system 100 (FIG. 1). In some embodiments, method 400 and other activities in method 400 can include using a distributed network including distributed memory architecture to perform the associated activity. This distributed architecture can reduce the impact on the network and system resources to reduce congestion in bottlenecks while still allowing data to be accessible from a central location.

Referring to FIG. 4, method 400 can include an activity 410 of receiving, at a system from a sender financial institution, transaction information for a requested payment transaction from a sender to a recipient. The system can be similar or identical to payment-messaging system 350 (FIG. 3). The sender can be similar or identical to sender financial institution 330 (FIG. 3). The system can be in data communication with a plurality of financial institutions of a payment network, which can include the sender financial institution (e.g., 330 (FIG. 3)), a recipient financial institution (e.g., 340 (FIG. 3)), and multiple other financial institutions (e.g., 360 (FIG. 3)).

In many embodiments, method 400 also can include an activity 420 of generating, using one or more machine-learning models, a risk score for the requested payment transaction based on analyzing the transaction information received from the sender financial institution and historical information regarding sender behavior of the sender and recipient behavior of the recipient obtained from the plurality of financial institutions of the payment network. In many embodiments, the machine-learning models can be similar or identical to risk mitigation model 353 (FIG. 3). In some embodiments, the sender behavior can include transaction history, activity levels, frequency of interactions with known recipients, frequency of interactions with unknown or new recipients, and/or typical transaction amounts sent of the sender across the payment network. In some embodiments, the recipient behavior can include transaction history, activity levels, typical transaction amounts received, frequency of interactions with known senders, frequency of interactions with new senders, and/or history of reported fraudulent activity of the recipient across the payment network. In some embodiments, activity 420 of generating the risk score further can include analyzing fraud incidents associated with public identifiers associated with the sender or the recipient. In many embodiments, the one or more machine-learning models can include an ensemble model. In some embodiments, the one or more machine-learning models can include a gradient boosted decision tree model. In other embodiments, other machine-learning models can be used.

In many embodiments, method 400 additionally can include an activity 430 of sending the risk score to the sender financial institution to cause the sender financial institution to determine whether to approve or deny the requested payment transaction.

In many embodiments, method 400 additionally can include an activity 440 of sending supplemental data regarding the risk score to the sender financial institution.

In many embodiments, method 400 additionally can include an activity 450 of receiving a message from the sender financial institution indicating an approval or a denial of the requested payment transaction.

In many embodiments, method 400 additionally can include an activity 460 of determining whether the sender financial institution approved or denied the requested payment transaction.

When the sender financial institution approved the requested payment transaction, method 400 can include an activity 470 of sending one or more payment messages to the recipient financial institution to cause the recipient financial institution to make funds available in a recipient account of the recipient at the recipient financial institution. In many embodiments, activity 470 can further include sending information included in the one or more payment messages and about the approval of the requested payment transaction for storage in a transaction database. The transaction database can be similar or identical to database 355 (FIG. 3).

When the sender financial institution denied the requested payment transaction, method 400 can include an activity 480 of storing information about the requested payment transaction and the denial in a transaction database.

In many embodiments, the systems and methods described herein can enable financial institutions to mitigate risk by making more informed decisions about transaction approvals or denials by providing a network-level risk assessment to identify potential fraud that could be missed by institution-specific controls. Financial institutions can conduct their due diligence by checking for behavior and on their end, but a single financial institution may not possess comprehensive information on both parties or fraud that has been attempted or carried out at other financial institutions. Fraudsters can move their tokens from one financial institution to another, and the new financial institution would not have any information of their fraud behavior at the previous financial institution. The risk mitigation model can better identify the transactions by holistically assessing both the senders and receiver at each transaction level.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although systems and methods for risk mitigation in real-time payment transactions has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that any element of FIGS. 1-4 may be modified, and that the foregoing discussion of certain of these embodiments does not necessarily represent a complete description of all possible embodiments.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising one or more processors and one or more non-transitory computer-readable media storing computing instructions that, when executed on the one or more processors, cause the one or more processors to perform operations comprising:
receiving, at the system from a sender financial institution, transaction information for a requested payment transaction from a sender to a recipient, wherein the system is in data communication with a plurality of financial institutions of a payment network, and the plurality of financial institutions comprise the sender financial institution, a recipient financial institution, and multiple other financial institutions;
generating, using one or more machine-learning models, a risk score for the requested payment transaction based on analyzing the transaction information received from the sender financial institution and historical information regarding sender behavior of the sender and recipient behavior of the recipient obtained from the plurality of financial institutions of the payment network; and
sending the risk score to the sender financial institution to cause the sender financial institution to determine whether to approve or deny the requested payment transaction.

2. The system of claim 1, wherein the operations further comprise:
sending supplemental data regarding the risk score to the sender financial institution.

3. The system of claim 1, wherein the operations further comprise:
receiving a message from the sender financial institution indicating an approval or a denial of the requested payment transaction.

4. The system of claim 3, wherein the operations further comprise, when the sender financial institution approved the requested payment transaction:
sending one or more payment messages to the recipient financial institution to cause the recipient financial institution to make funds available in a recipient account of the recipient at the recipient financial institution.

5. The system of claim 3, wherein the operations further comprise, when the sender financial institution denied the requested payment transaction:
storing information about the requested payment transaction and the denial in a transaction database.

6. The system of claim 1, wherein the sender behavior comprises transaction history, activity levels, and typical transaction amounts sent of the sender across the payment network.

7. The system of claim 1, wherein the recipient behavior comprises transaction history, activity levels, typical transaction amounts received, frequency of interactions with new senders, and history of reported fraudulent activity of the recipient across the payment network.

8. The system of claim 1, wherein generating the risk score further comprises analyzing fraud incidents associated with public identifiers associated with the sender or the recipient.

9. The system of claim 1, wherein the one or more machine-learning models comprise an ensemble model.

10. The system of claim 1, wherein the one or more machine-learning models comprise a gradient boosted decision tree model.

11. A computer-implemented method comprising:
receiving, at a system from a sender financial institution, transaction information for a requested payment transaction from a sender to a recipient, wherein the system is in data communication with a plurality of financial institutions of a payment network, and the plurality of financial institutions comprise the sender financial institution, a recipient financial institution, and multiple other financial institutions;
generating, using one or more machine-learning models, a risk score for the requested payment transaction based on analyzing the transaction information received from the sender financial institution and historical information regarding sender behavior of the sender and recipient behavior of the recipient obtained from the plurality of financial institutions of the payment network; and
sending the risk score to the sender financial institution to cause the sender financial institution to determine whether to approve or deny the requested payment transaction.

12. The computer-implemented method of claim 11, wherein the method further comprises:
sending supplemental data regarding the risk score to the sender financial institution.

13. The computer-implemented method of claim 11, wherein the method further comprises:
receiving a message from the sender financial institution indicating an approval or a denial of the requested payment transaction.

14. The computer-implemented method of claim 13, wherein the method further comprises, when the sender financial institution approved the requested payment transaction:
sending one or more payment messages to the recipient financial institution to cause the recipient financial institution to make funds available in a recipient account of the recipient at the recipient financial institution.

15. The computer-implemented method of claim 13, wherein the method further comprises, when the sender financial institution denied the requested payment transaction:
storing information about the requested payment transaction and the denial in a transaction database.

16. The computer-implemented method of claim 11, wherein the sender behavior comprises transaction history, activity levels, and typical transaction amounts sent of the sender across the payment network.

17. The computer-implemented method of claim 11, wherein the recipient behavior comprises transaction history, activity levels, and typical transaction amount received, frequency of interactions with new senders, and history of reported fraudulent activity of the recipient across the payment network.

18. The computer-implemented method of claim 11, wherein generating the risk score further comprises analyzing fraud incidents associated with public identifiers associated with the sender or the recipient.

19. The computer-implemented method of claim 11, wherein the one or more machine-learning models comprise an ensemble model.

20. The computer-implemented method of claim 11, wherein the one or more machine-learning models comprise a gradient boosted decision tree model.
